(19) United States
(12) Patent Application Publication
(10) Pub. No.: US 2007/0283346 A1
(43) Pub. Date: Dec. 6, 2007

(54) System and method for remote management and facilitating installation and registration of software

(76) Inventors: David Delgrosso, Naperville, IL (US); Fraser Orr, Naperville, IL (US)

Correspondence Address: SCHWARTZ COOPER CHARTERED;IP DEPARTMENT, 180 NORTH LASALLE STREET, SUITE 2700, CHICAGO, IL, 60601, US

(21) Appl. No.: 11/789,042

(22) Filed: Apr. 23, 2007

Related U.S. Application Data
(60) Provisional application No. 60/794,169, filed on Apr. 21, 2006.

(51) Int. Cl. G06F 9/445

(52) U.S. Cl. 717/176

(57) ABSTRACT

A system and method for automatically installing software applications on a client computer in a networked environment, and for allowing management rights to a one or more enterprise server. To automatically install software applications, an administer imports registration codes for the application to a database, creates an installation program having set installation parameters and which obtains an appropriate registration code from the database, and distributes the installation program to the end users. Additionally, the administrator can set up administrative rights for various users on distinct enterprise servers. An authentication server can be utilized to facilitate this process.

### CROSS-REFERENCE TO RELATED APPLICATIONS

The present invention claims the benefit of U.S. Provisional Application No. 60/794,169 filed Apr. 21, 2006. Additionally, the present invention is a further development to the inventions disclosed in U.S. application Ser. No. 10/932,979, filed Sep. 2, 2004 and titled “Access Administration System and Method” and U.S. application Ser. No. 11/051,259, filed Feb. 4, 2005 and titled “Access Administration System and Method for a Currency Compartment.” All of these applications are incorporated herein by reference.

### FEDERALLY SPONSORED RESEARCH OR DEVELOPMENT

N/A

### TECHNICAL FIELD

The invention generally relates to a system and method for remotely managing a server and for automatically installing a software application on the server, and more particularly, to a system and method for granting administrator access to one more separate servers for distinct enterprises and to a system and method for configuring an installation program for automatically installing a software application in accordance with an IT administrator's settings on a plurality of client computers without user interaction.

### BACKGROUND OF THE INVENTION

It is often necessary to install new software applications on a number of computers which are typically connected in a network. For example, a business having a large number of employees—each utilizing their own computer—may want each employee to have access to a particular new application, or to upgrade an application currently used by each of the employees.

The installation of a new software application or upgrade to a large number of client computers can be time consuming for each user and/or require the intervention or assistance of the business's information technology (IT) specialist. Moreover, a number of problems can result from the installation. For example, configuration inconsistencies can result between applications loaded onto different computers. This may occur because each user is typically provided (and possibly selects) different options in how the application is installed by the installation software. This may also be the result of a user incorrectly entering installation data.

With typical software installations, a user is asked or prompted by the installation software a series of installation questions, such as the location (IP address and port) of the server, and at least one very long alpha numeric code to legitimately and properly register and activate the software. Some software installations provide recommended or typical installation settings. However, such installations do not provide for all settings or properties.

Additionally, the installation software typically requires each user to enter a registration code or license key when installing an application. This can provide another source for delay or errors in the installation process.

Other problems arise in networked systems that connect a plurality of separate servers for distinct enterprises. In particularly, granting a user administrator access to one or more servers can be problematic in that each server will need to identify and verify the administrative status for each such user. A change in a user's status or the addition or deletion of users will require each server to be provided updated data.

The present invention is provided to solve the problems discussed above and other problems, and to provide advantages and aspects not provided by prior systems of this type. A full discussion of the features and advantages of the present invention is deferred to the following detailed description, which proceeds with reference to the accompanying drawings.

### SUMMARY OF THE INVENTION

The present systems and methods work in connection with a central management application or program that is utilized with a plurality of servers or computers in a network. The invention provides a consistent and automatic installation of software applications (i.e., programs) onto a plurality of client servers or computers, and also provides a mechanism for allowing remote management by an administrator of an enterprise server for an entity that is distinct and separate from other entities in the system.

According to one aspect of the invention, a method for facilitating installation of a software application in a plurality of client computers is provided. The method includes creating a client software installation program for installing a software application in accordance with parameters set by an administrator of the system. This can be done by the administrator by writing a script or other program and/or modifying installation software accompanying the application. The client software installation program is for use by a plurality of client computers. The method further includes importing a plurality of registration codes for the software application and storing the registration codes in a database accessible to the plurality of client computers.

The method also includes setting up the client software installation program for automatically installing the software application into each of the plurality of client computers when selectively initiated by each of the plurality of client computers. This can require providing setup information for the software application for use on a client computer and, providing a configuration for automatically retrieving one of the registration codes stored in the database. The setup information can be stored in a setup file called to by the installation program, and can include all of the setup parameters (at the administrator's direction) for the application being installed.

The method further includes providing the client software installation program to the plurality of client computers. This step can performed by loading the installation program onto a CD or other portable medium, or placing it on a network accessible to the plurality of client computers. The client computers initiate the client software installation program which automatically installs the software application in the client computer, without further user intervention.

The setup information can include group policies and software properties of the application mandated for all of the plurality of client computers. This ensures the application is consistently loaded throughout the network in accordance with the parameters set forth by the administrator.

In accordance with another aspect of the invention, a system for automatically installing a software application on a plurality of networked client computers is also provided. The system includes a data file containing a plurality of registration codes for a software application, and an installation program configured for automatically installing the software application on a client computer upon initiation by a user. The installation program is further configured to install the software application in accordance with setup information (such as group policies of the enterprise utilizing the application, or setup parameters or settings of the application), and to retrieve a registration code from the plurality of registration codes. The information can be customized for the plurality of networked client computers and can be placed in a setup file callable by the installation program.

In accordance with a further aspect of the invention, a system for allowing remote management of a plurality of enterprises is also provided. The system includes a plurality of enterprise servers, and an authentication server accessible to the plurality of enterprise servers. The authentication server is configured to store personal information of authorized users having administrative privileges on the enterprise servers and identify each enterprise server for which each authorized user has the administrative privileges. Each enterprise server in this system maintains applications and data related to a distinct, separate enterprise.

The system can be setup so that each enterprise server is configured to identify and verify a user's administrative privileges on the enterprise server. When the enterprise server is not able to verify a user, the enterprise server is configured to connect to the authentication server to identify and verify a user's administrative privileges on the enterprise server. The verification data can include biometric information of the user, such as a fingerprint scan. The enterprise servers or user's work stations can be provided with appropriate equipment (e.g., a scanner) to provide the biometric data of the user.

Additionally, the authentication server can be configured to enroll a new administrative user for one of the plurality of enterprise servers. An administrator already having such privileges can perform the enrollment.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a block diagram of examples of the remote management system in accordance with an aspect of the present invention.

FIG. 2 is a block diagram of the system and method for automatically installing software in accordance with an aspect of the present invention.

FIG. 3 a block diagram of the system for remote management in accordance with an aspect of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

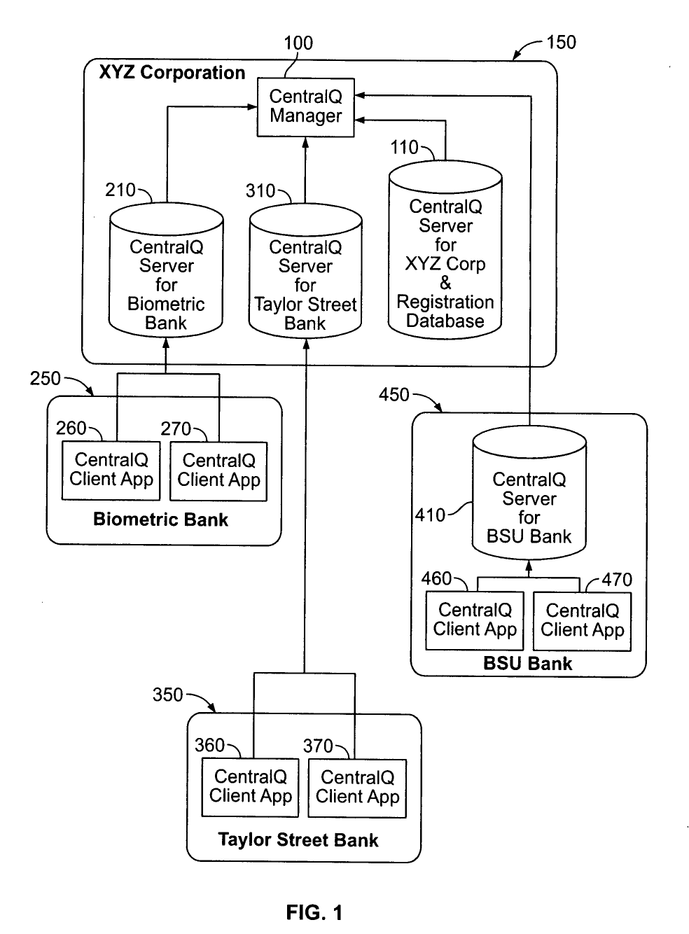

As shown in FIGS. 1-3, the present invention provides systems and methods that can be utilized in various networked environments. Specifically, the invention provides for installation of software (i.e., an application or program) among a plurality of client computers or servers, that is consistently setup in each client computer and does not require user interaction in the installing process (other than starting the installation software). The invention also provides for enabling an administrator to remotely manage one or more enterprise server, where each enterprise server is for a distinct, separate entity.

The present system and method is utilized to overcome a number of problems typically encountered when attempting to install new or upgraded software on a large number of networked computers in an enterprise or business. Such problems can include configuration inconsistencies between computers, or other errors caused by user installation. These are typically caused when each user is allowed, or required, to provide some kind of input in the installation process.

The present system allows the enterprise, typically through an IT (information technology) administrator or manager, to setup installation of the application so that it is installed in accordance with the IT departments specifications on each computer. Specifically, the IT administrator configures a client installation software to automatically install the software application in accordance with such specifications. The client installation software can then be used for any number (i.e., hundreds, or in some cases thousands) of installations. This will cut down on end user time of installation, configuration errors and inconsistencies, and mandate client software policies of the enterprise. The client installation software (as configured by the IT administrator) can also be used to manage use of registration codes associated with the application. Use of the client installation software will also result in less time spent troubleshooting by the IT department.

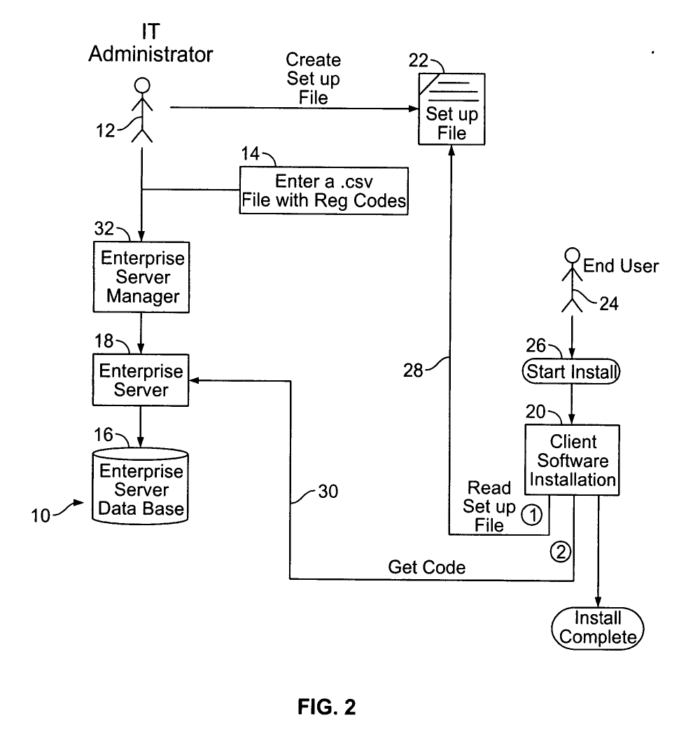

The system 10 (and associated method) for automatically installing a software application on a plurality of computers is illustrated in the embodiment of the invention shown in FIG. 2. The system allows an enterprise (e.g., a business) to easily deploy server software to a number of computers in a networked environment.

An administrator 12 (such as the IT administrator having special access rights or permission to view and manage configurations and data of an enterprise server) is provided with a data file 14 containing a number of registration codes associated with a software application (e.g., a new software program) to be added to the networked computers. The registration codes—also known as registration keys or license keys—are used to authorize installation of versions of the software application onto the computers.

The administrator 12 loads or imports the data file 14 onto a database 16 of an enterprise server 18 associated with the networked computers. The enterprise server 18 is a remote software application that provides computer processing services and stores remote data for its client software. The enterprise server database 16 can be any known memory or data storage system associated (either directly or via another server system) with the enterprise server 18.

The software application is preferably client software that uses the enterprise server 18. The software application is loaded onto each of the client computers by client installation software 20 associated with the software application. The client installation software is a program that installs and configures the software application (e.g., client software) being loaded onto the computer.

In accordance with the present invention, the administrator 12 creates from scratch or modifies existing client installation software in order to install the software application in accordance with setup information determined by the administrator. The setup information can include group policies of the enterprise's IT department, as well as application properties (i.e., the software application's specific configuration or settings, such as the IP address and Port of the enterprise server 18, installation directory, default settings, etc.). That is, the client installation software is configured by the administrator 12 to mandate group policies and application properties for all end user client computers. Because all of the settings are done one time by the administrator in connection with the client installation software, the software application will be set up in each client computer the same way. This removes inconsistencies and errors that were typically encountered when the user of the client computer was given the option, or required, to provide input in the installation process.

The setup information can be incorporated directly in the client installation software 20, or can be placed in a specially formatted setup file 22 that can be accessed by the client installation software 20. In addition to the setup information, the setup file 22 can include a configuration that tells the client installation software that it is an “automatically activating” installation, and identifies an IP address and Port of the enterprise server database 16 form locating registration codes associated with the software application being installed.

The client installation software 20 and the setup file 22 can be copied to a portable storage medium (e.g., a compact disc, DVD, flash memory card, etc.) and provided to an end user 24 to install on the user's client computer. Alternatively, the client installation software 20 and/or the setup file 22 can be placed on a network shared drive accessible to the client computers 26.

In operation, the end user 24 of one of the network computers 26 initiates or starts (i.e., runs) the client installation software 20 on the user's computer 26. The client installation software 20 is configured to first look for (see e.g., reference no. 28) the setup file 22. The setup file 22 provides the setup information for the software application, and a configuration for automatically retrieving a registration code from the enterprise server database 16 (or any other location the codes may be stored). The client installation software then proceeds to automatically install the software application under the parameters set by the administrator 12, including obtaining 30 and utilizing the registration code. After initializing the client installation software 20, no further user 24 interaction is required. The end user 24 does not have to locate and enter the registration code or make any decision regarding the installation of the software application. Instead, the application is installed in accordance with the administrators preferences. In this manner, the application can be consistently installed on all computers in the network.

An enterprise server manager 32 can be utilized to facilitate implementation of the above functions by the administrator 12, including creating the client installation software. Additionally, the enterprise server manager 32, or other applications associated with the enterprise server 18, can be used to obtain and manage the registration codes. Specifically, the system can be used to store, track and manage use of the registration codes. This can be particularly valuable for systems utilizing hundreds or thousands of codes.

The process can be utilized to load a central management application throughout a network. As shown in FIG. 1, the administrator portion of a central management software (given the name “CentralQ” manager) on a server 100 permits an administrator to create a one time installation script to allow for no questions to be asked during a CentralQ application software installation process by the individual clients. As such, the questions for the individual clients are already answered or by-passed because the administrator has already set up all parameters for installing the application. In addition, or in the alternative, the software (i.e., CentralQ) 100 has created a special registration database 110 housing valid registration codes. As a result, the CentralQ application will go to the registration database 110 for valid codes instead of prompting the user to fill such information in. Thus, CentralQ applications from separate customers (e.g., 460,470) may poll the same registration database 110 allowing for easier maintainability. A report can be generated by the administrator to show which organization has taken codes for which products, and billing can be made appropriately.

Again referring to FIG. 1, the central management application 100 can be utilized to allow for the management of distinct enterprises. As shown in FIG. 1, from the CentralQ Manager 100 (located at XYZ Corporation 150), an administrator is capable of managing the application and user data of separate customer data stores 250,350,450. For example: In XYZ Corp. 150 one can manage the IT infrastructure of Biometric Bank 250, Taylor Street Bank 350 and BSU Bank 450. These banks 250,350,450 are separate entities, both legally and physically, and their data is not to be stored together.

Specifically, the CentralQ manager 100 is connected to other servers by well-known means both on-premise and off-premise, and to the registration database 110. As shown in FIG. 1, Biometric Bank's server 210 and Taylor Street Bank's server 310 are physically at XYZ Corporation 150 and BSU Bank's server 410 is at BSU Bank's facilities 450.

The central administrator at XYZ Corp. 150 can thus log on to the main server 100 hosting Biometrics Bank's data 210,260,270 using the CentralQ Manager. After administering Biometric Bank's data, the administrator using the CentralQ Manager 100 can log off of Biometric Bank's Server 210 and then log on to Taylor Street Bank's server 310 to administer that bank's data, 310,360,370. The administrator can do the same with BSU Bank's server 410 to access its data 410,460,470 and perform administrator functions.

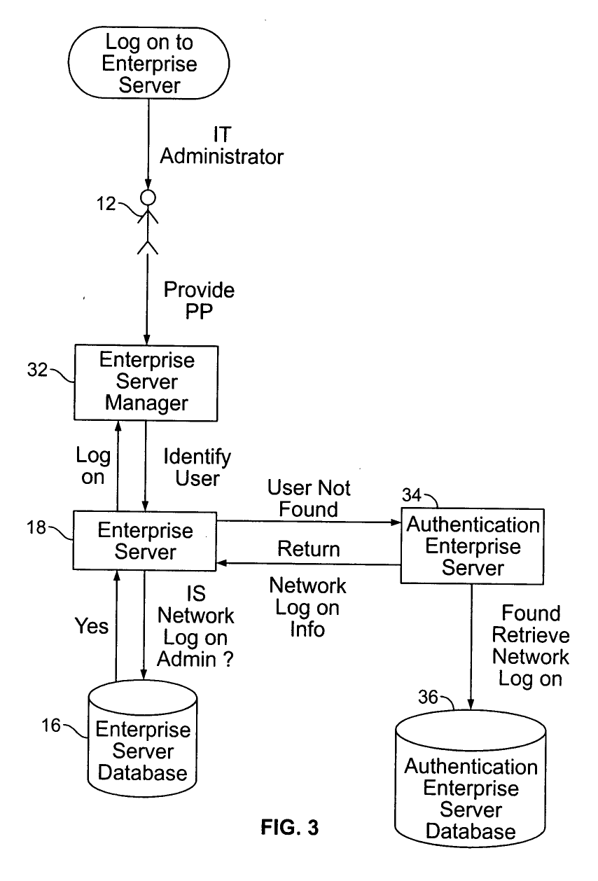

Referring also to FIG. 3, to implement this system, a full administrator configures an enterprise server 18 to identify and verify an administrator's 12 administrative privileges. If found by the enterprise server 18, the potential administrator's 12 Network user name and password are verified against the Windows Network, and the enterprise server 18 determines if the Windows' user name and password have been established in itself (not the Enterprise Authentication Server) as an administrator 12 having rights to the enterprise server 18. If all of these cases are true the user is in fact an administrator 12 for the enterprise server 18 in question and the administrator 12 may view and manage this enterprise server 18. If identification is not found, the enterprise server 18 will attempt to identify the potential administrator on an enterprise authentication server 34.

Before a user is able to take advantage of viewing and managing segregated enterprise servers (such as those shown in FIG. 1) the user must first be enrolled to the enterprise authentication server 34 and granted access to each enterprise server 18 deemed necessary. To accomplish this, a previously enrolled administrator, with rights to perform these enrolling and permission granting access functions, must already be enrolled to the enterprise authentication server 34 and be an administrator in the enterprise servers 18.

The administrator 12 enrolls a user by adding the user's personal information, fingerprint (or other biometric data) and Network user name and password to the enterprise authentication server 34. All of this information can be stored in an enterprise authentication server database 36 associated with the enterprise authentication server 34. The administrator 12 now closes the enterprise authentication server 34 and logs on to the enterprise server 18 where he or she wishes to grant administrator access for the user. The administrator 12 gives the user access to the Enterprise Server by associating the user's Network user name to administrator permission. The user is now an administrator for this server software 18. The administrator 12 will perform this action on each enterprise server it is deemed necessary to give a user administrator privileges to.

Administrators can be placed in groups on the enterprise authentication server 34. Each group may be granted administrative rights to a particular enterprise server 18. This allows the simple adding or deleting of a person from these groups to control who may administer a particular enterprise server or group of servers.

While the specific embodiments have been illustrated and described, numerous modifications come to mind without significantly departing from the spirit of the invention, and the scope of protection is only limited by the scope of the accompanying Claims.

What is claimed is:

1. A method for facilitating installation of a software application in a plurality of client computers comprising the steps of:
creating a client software installation program for installing a software application, wherein the client software installation program is for use by a plurality of client computers;
importing a plurality of registration codes for the software application and storing the registration codes in a database accessible to the plurality of client computers; and,
setting up the client software installation program for automatically installing the software application into each of the plurality of client computers when selectively initiated by each of the plurality of client computers including:
providing setup information for the software application for use on a client computer; and,
providing a configuration for automatically retrieving one of the registration codes stored in the database.

2. The method of claim 1 further comprising the steps of:
providing the client software installation program to the plurality of client computers;
initiating the client software installation program by a select client computer of the plurality of client computers; and,
automatically installing the software application in the select client computer by the client software installation program.

3. The method of claim 2 wherein the step of providing the client software installation program to the plurality of client computers comprises:
loading the software installation program onto a portable storage medium which can be selectively run by the plurality of client computers.

4. The method of claim 2 wherein the step of providing the client software installation program to the plurality of client computers comprises:
placing the client software installation program on a network accessible to the plurality of client computers.

5. The method of claim 1 wherein the step of automatically installing the software application in the select client computer by the client software installation program comprises
setting up the software application at the client computer without client user interaction.

6. The method of claim 2 wherein providing the software application setup information for use on a client computer comprises:
providing a setup file containing software application setup information.

7. The method of claim 6 wherein the software application setup information includes group policies mandated for all of the plurality of client computers.

8. The method of claim 6 wherein the software application setup information includes software properties mandated for all of the plurality of client computers.

9. A system for automatically installing a software application on a plurality of networked client computers comprising:
a data file containing a plurality of registration codes for a software application;
an installation program configured for automatically installing the software application on a client computer upon initiation by a user, the installation program further configured to install the software application in accordance with setup information, and to retrieve a registration code from the plurality of registration codes.

10. The system of claim 9 wherein the setup information includes settings for the software application.

11. The system of claim 9 wherein the setup information includes group policies for the software application.

12. The system of claim 9 further comprising a setup file callable by the installation program, the setup file containing the setup information.

13. The system of claim 9 wherein the installation program and software application are stored on a portable storage medium.

14. The system of claim 9 wherein the data file containing a plurality of registration codes is maintained on a database accessible to the plurality of client computers.

15. The system of claim 9 wherein the setup information is customized for the plurality of networked client computers.

16. A system for allowing remote management of a plurality of enterprises comprising:
a plurality of enterprise servers, each enterprise server maintaining applications and data related to a distinct, separate enterprise; and,
an authentication server accessible to the plurality of enterprise servers configured to store personal information of authorized users having administrative privileges on the enterprise servers and identify each enterprise server for which each authorized user has the administrative privileges.

17. The system of claim 16 wherein each enterprise server is configured to identify and verify a user's administrative privileges on the enterprise server.

18. The system of claim 17 wherein the enterprise server is configured to connect to the authentication server to identify and verify a user's administrative privileges on the enterprise server.

19. The system of claim 16 wherein the personal information includes biometric information of the user.

20. The system of claim 16 wherein the authentication server is configured to enroll a new administrative user for one of the plurality of enterprise servers.
